(19) United States
(12) Patent Application Publication
(10) Pub. No.: US 2022/0081124 A1
(43) Pub. Date: Mar. 17, 2022

(54) AIRCRAFT PROJECTION DEVICE

(71) Applicant: KOITO MANUFACTURING CO., LTD., Tokyo (JP)

(72) Inventor: Shigeo SAWADA, Shizuoka (JP)

(21) Appl. No.: 17/418,842

(22) PCT Filed: Dec. 25, 2019
(86) PCT No.: PCT/JP2019/050964

§ 371 Date: Jun. 27, 2021

(30) Foreign Application Priority Data
Jan. 18, 2019 (JP) 2019-007153

(51) Int. Cl. B64D 47/02; G08G 5/04

(52) U.S. Cl. CPC B64D 47/02; G08G 5/045

(57) ABSTRACT

An aircraft projection device attached to an airframe of an aircraft and used in a landing state includes: a projector configured to project and display an image on a road surface outside the aircraft; and a controller configured to control the projector to display the image.

### TECHNICAL FIELD

The present disclosure relates to an aircraft projection device that projects and displays an image.

### BACKGROUND

An aircraft is provided with various lamps depending on the purpose of use. For example, as an external illumination, there are provided a collision prevention lamp that prevents collision between aircrafts, an aviation lamp that indicates a flight posture of an airframe or a flight direction, a landing lamp that irradiates a runway during take-off and landing, and a logo lamp that illuminates a logo printed on the airframe (see, e.g., Patent Document 1 and Patent Document 2).

With such external illumination, a safe flight state and a safe traveling state on the runway during take-off and landing of the aircraft are secured.

### PRIOR ART DOCUMENT

### Patent Document

Patent Document 1: Japanese Patent Laid-Open Publication No. 2010-033840;

Patent Document 1: Japanese Patent Laid-Open Publication No. 2010-033841.

### SUMMARY OF THE INVENTION

### Problem to be Solved

While many aircrafts take off and land at an airport, the number of runways is limited. Therefore, it is required to secure a smooth and safe traveling state on the runways. Further, after landing or before take-off, a lot of work such as refueling work or inspection work of each part by a ground worker is required. Therefore, in order to promote safe traveling or safe and quick work, it is desirable to improve convenience for a pilot or a ground worker.

Therefore, an aircraft projection device of the present disclosure is to improve convenience for a pilot or a ground worker.

### Means to Solve the Problem

An aircraft projection device according to the present disclosure attached to an airframe of an aircraft and used in a landing state, includes: a projector configured to project and display an image on a road surface outside the aircraft; and a controller configured to control the projector to display the image.

Therefore, it is possible for the pilot or the ground worker to visually recognize the image displayed on the road surface outside the aircraft and recognize matters provided to the pilot or the ground worker.

Secondly, in the aircraft projection device according to the present disclosure, projecting light may be emitted directly downward from the projector.

Therefore, since a distance from the projector to each display portion in the image does not differ significantly, so that a shape of the image or characters displayed on the road surface are unlikely to be distorted.

Thirdly, in the aircraft projection device according to the present disclosure, the projector may be attached to an inner surface of a storage cover that opens and closes a front leg that is taken in and out of a fuselage of the aircraft.

Therefore, it is possible to use the projector in a state where the storage cover is opened.

Fourthly, in the aircraft projection device according to the present disclosure, the projector may display a running direction of the aircraft as an image.

Therefore, since the running direction of the aircraft is displayed on the road surface during take-off and landing, it is possible for the pilot or the ground worker to recognize the running direction of the aircraft with the naked eyes.

Fifthly, in the aircraft projection device according to the present disclosure, the projector may display a warning mark as an image.

Therefore, it is possible for the ground worker to recognize the warning state with the naked eye.

### Effect of the Invention

According to the present disclosure, it is possible for the pilot or the ground worker to visually recognize the image displayed on the road surface outside the aircraft and recognize matters provided to the pilot or the ground worker. In addition, it is possible to improve convenience for the pilot or the ground worker.

### BRIEF DESCRIPTION OF THE DRAWINGS

FIG. 1 illustrates an embodiment of an aircraft projection device according to the present disclosure together with FIGS. 2 to 9, and is a side view of an aircraft illustrating in a state where a storage cover is closed.

FIG. 2 is a plan view illustrating a state where an image is displayed.

FIG. 3 is a front view of an aircraft illustrating a state where a storage cover is opened.

FIG. 4 is a block diagram of an aircraft projection device.

FIG. 5 is a flowchart illustrating a processing of a controller of the aircraft projection device.

FIG. 6 illustrates an operation example of an aircraft projection device together with FIGS. 7 and 8, and is a view illustrating a state where an aircraft is waiting in a waiting area.

FIG, 7 is a view illustrating a state where an aircraft is traveling toward a runway.

FIG. 8 is a view illustrating a state where an aircraft is traveled to a runway and is waiting.

FIG. 9 is a view illustrating examples of drawing contents of an image.

### DETAILED DESCRIPTION TO EXECUTE THE INVENTION

Hereinafter, embodiments will be described with reference to the drawings.

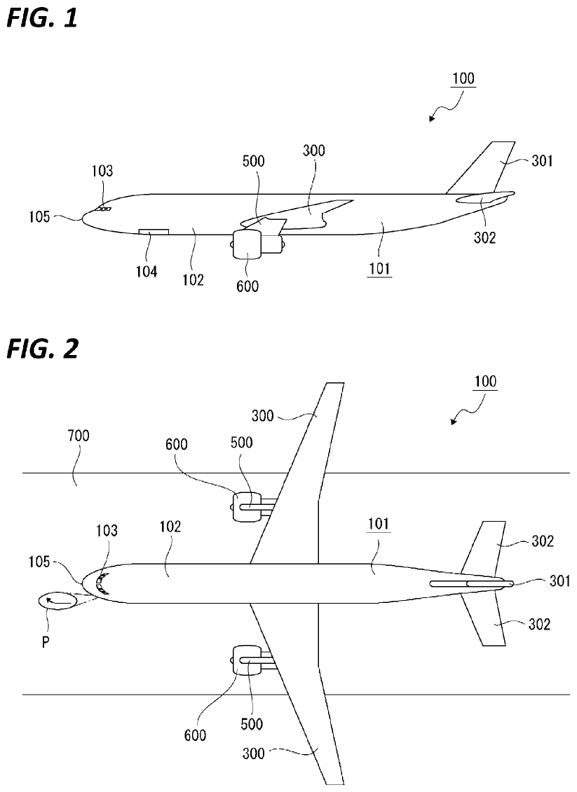

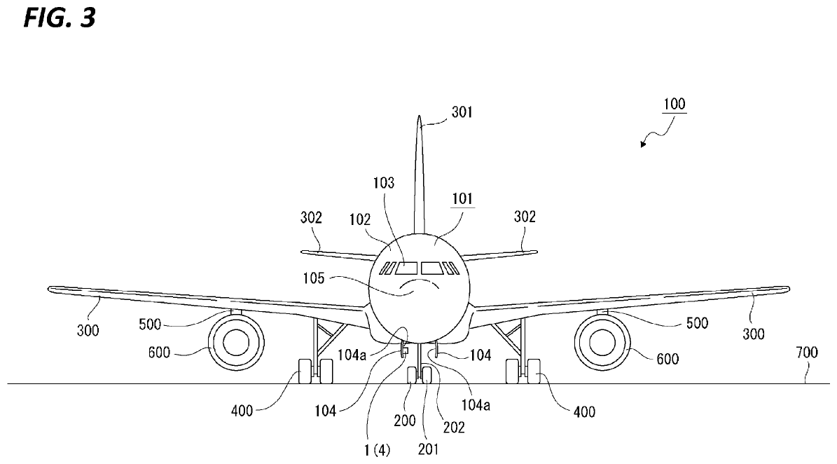

An airframe 101 of an aircraft 100 includes a fuselage 102 and various wings (see FIGS. 1 to 3). A window 103 for usually recognizing the outside from a cockpit is attached to a front end portion of the fuselage 102. Storage covers 104 and 104 are provided at a lower end portion of the front end portion of the fuselage 102 to be openable and closable (see FIGS. 1 and 3). The storage covers 104 and 104 are opened to protrude a front leg 200 from the inside of the fuselage 102, and when the front leg 200 is stored inside the fuselage 102, the storage covers 104 and 104 are closed, and the front leg 200 is protected by the storage covers 104 and 104. The front end portion of the fuselage 102 is provided as a radome 105.

The front leg 200 includes a front wheel 201 for traveling and a support column 202 that supports the front wheel 201. As the gs of the aircraft 100, main wings 300 and 300, a vertical tail wing 301, and horizontal tail wings 302 and 302 are provided (see FIGS. 1 to 3).

Storage covers (not illustrated) at the rear side are provided at the main wings 300 on the left and right sides or at a position from the main wing 300 to the fuselage 102 to be openable and closable, and when the storage covers at the rear side is opened and closed, real legs 400 protrude from the inside of the fuselage 102 or are stored inside the fuselage 102, respectively.

A zet engine 600 is attached to the each of the main wings 300 on the left and right sides via a pylon 500.

An aircraft projection device 1 is attached to an inner surface 104a of the storage cover 104 (see FIG. 3). However, at least a projector (to be described later) of the aircraft projection device 1 may be attached to the storage cover 104. Meanwhile, aircraft projection devices 1 and 1 may be attached to the inner surfaces 104a and 104a of the storage covers 104 and 104 on both the left and right sides, respectively. Further, the aircraft projection device 1 or the projector may he attached to any position of the airframe 101 as long as an image may be projected on a road surface 700 outside the aircraft 100, without limiting to the storage cover 104.

By attaching the aircraft projection device 1 to the inner surface 104a of the storage cover 104, the aircraft projection device 1 is exposed during the landing of the aircraft 100, and the aircraft projection device 1 is stored inside the fuselage 102 during the flight of the aircraft 100 so that the aircraft projection device 1 is protected.

Further, for example, the aircraft projection device 1 may be attached to the support column 202 of the front leg 200, and in this case, similar to the case where the aircraft projection device 1 is attached to the inner surface 104a of the storage cover 104, the aircraft projection device 1 is exposed during the landing of the aircraft 100, and the aircraft projection device 1 is stored inside the fuselage 102 during the flight of the aircraft 100 so that the aircraft projection device 1 is protected.

However, when the aircraft projection device 1 is attached to the support column 202, impact is likely to he applied to the aircraft projection device 1 via the front wheel 201 when the aircraft 100 lands on the runway, and thus, it is more desirable that the aircraft projection device 1 is attached to the storage cover 104, which has less impact at the time of landing.

In a state where the aircraft 100 has landed, an image P is projected onto the road surface 700 by the aircraft projection device 1, and the image P is displayed (see FIG. 2). As the image P, for example, a running direction of the aircraft 100 is displayed. The image P is displayed on the front side or the diagonal front side of the aircraft 100, and may be visually recognized from a pilot or a co-pilot seated in a cockpit seat. Therefore, the pilot or the co-pilot recognizes the running direction toward the runway during take-off. Further, by displaying the running direction as the image P, it is possible to facilitate communication with a ground guide (marshaller) who guides the running of the aircraft 100.

Meanwhile, the position at which the image P is displayed may be on the side or the diagonal rear side of the aircraft 100, or may be a position that is visually recognizable from the pilot or the co-pilot seated in the cockpit seat.

The image P that indicates the running direction of the aircraft 100 is displayed, for example, when a preparing work before take-off is performed on the aircraft 100 or when being in the state immediately before take-off. At this time, various works are performed by the ground worker. For example, the ground worker loads luggage into a cargo compartment of the aircraft 100, inspects each part of the aircraft 100, refuels the aircraft 100, or cleans the aircraft 100, and the ground worker visually recognizes the image P so as to recognize the running direction of the aircraft 100.

Further, the image P is displayed on the road surface 700 while the image P that indicates the correct running direction is switched, even during the traveling toward the runway after the aircraft 100 starts the traveling.

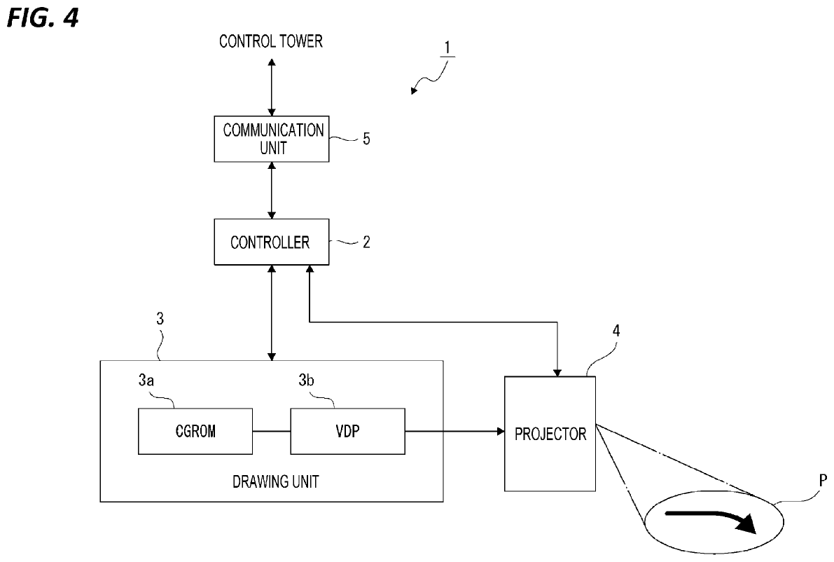

Hereinafter, an example of a configuration of the aircraft projection device 1 will be described (see FIG. 4).

The aircraft projection device 1 includes a controller 2, a drawing unit 3, a projector 4, and a communication unit 5.

The controller 2 is configured by a micro computer including, for example, a central processing unit (CPU), a random access memory (RAM), a read only memory (ROM), and an electrically erasable programmable read only memory (EEPROM), and performs an operation control of the drawing unit 3 or the projector 4 based on information input from the communication unit 5.

The drawing unit 3 performs a processing that generates contents of the drawing in the image P, and includes, for example, a character generator roan (CG-ROM) 3a or a video display processor (VDP) 3b.

The CG-ROM 3a stores various material images P used for drawing. The VDP 3b performs the drawing of the image P using the material image read from the CG-ROM 3a, and supplies the drawing data to the projector 4. The drawing unit 3 performs the drawing of a necessary content at necessary timing in accordance with, for example, an instruction from the controller 2.

The projector 4 includes, for example, a light source unit, a light modulation unit, and a projection lens, and projects the image P based on the drawing data transferred from the drawing unit 3 to display the image P on the road surface 700.

Examples of the light source unit include various light sources such as a light emitting diode (LED), a laser light source, a xenon lamp, and a mercury lamp. Examples of the light modulation unit include a liquid crystal light valve. The image P drawn by the drawing unit 3 is displayed on the road surface 700 by controlling the light crystal light valve according to the drawing data, and modulating the projecting light by the light modulation unit.

The communication unit 5 communicates with an airport or a control tower at a position other than the airport. For example, the communication unit 5 receives a command from the control tower, and sends a projection start command or a projection end command for the aircraft projection device 1 to the controller 2. The control tower monitors the current state of the aircraft 100 at any time, and grasps and discriminates a progress situation of various works on the aircraft 100 before take-off, an inspection result of the inspection work, the usage situation of the runway, and possible take-off time, and sends the command to the communication unit 5 based on such information.

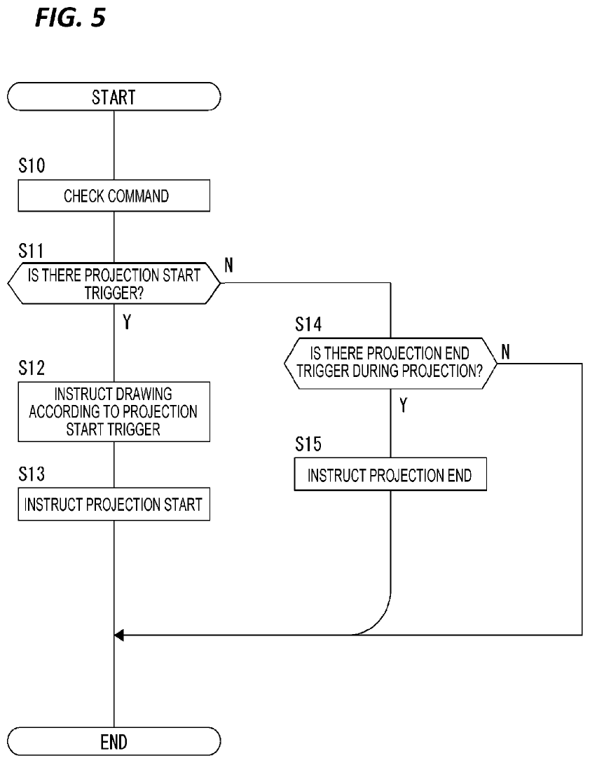

In the aircraft projection device 1 configured as described above, the controller performs, for example, the following controls (see FIG. 5). Meanwhile, the controller 2 performs a processing at every predetermined timing, and repeatedly performs the following processings.

In step S10, the controller 2 confirms the reception of the command via the communication unit 5 from the control tower by a command check.

In step S11, the controller 2 determines the presence or absence of a projection start trigger based on the command check in step S10. The projection start trigger is a predetermined condition to start the display of the image F, and occurs, for example, when the projection start condition is satisfied in a state where the communication unit 5 receives the projection start command. The determination condition of the projection start trigger may be set according to the usage aspect of the aircraft projection device 1.

The projection start trigger is, for example, a command that is suitable for the material image with the command stored in the CG-ROM 3a in the command check by step 10, and occurs when reaching the timing of displaying the image P calculated from the scheduled take-off time.

When it is determined that the projection start trigger occurs, the controller 2 proceeds from step S11 to step S12, and instructs the drawing for projection of the image P according to the determined projection start trigger. That is, the controller 2 instructs the execution of the drawing and the contents of the image P for the drawing unit 3.

In step S13, the controller 2 instructs the projector 4 to start projection. Therefore, the projection based on the drawing data generated by the drawing unit 3 is started by the projector 4, and a predetermined image P is displayed on the road surface 700.

Meanwhile, when it is determined that the projection start trigger does not occur in step S11, the controller 2 determines whether or not the projection end trigger has occurred during projection in step S14. The projection end trigger is a predetermined condition to end the display of the image P, and occurs, for example, when the communication unit 5 receives the projection end command. The determination condition of the projection end trigger may be set corresponding to the projection start trigger.

When the projection is not performed, one processing is ended from step S14.

During the projection, the controller 2 determines in step S14 whether or not the projection end trigger has occurred based on the command check in the immediately preceding step S10.

When it is determined that the projection end trigger occurs during projection, the controller 2 proceeds from step S14 to step S15, and instructs the projector 4 to end the projection. Therefore, the projection by the projector 4 based on the drawing data generated by the drawing unit 3 is ended.

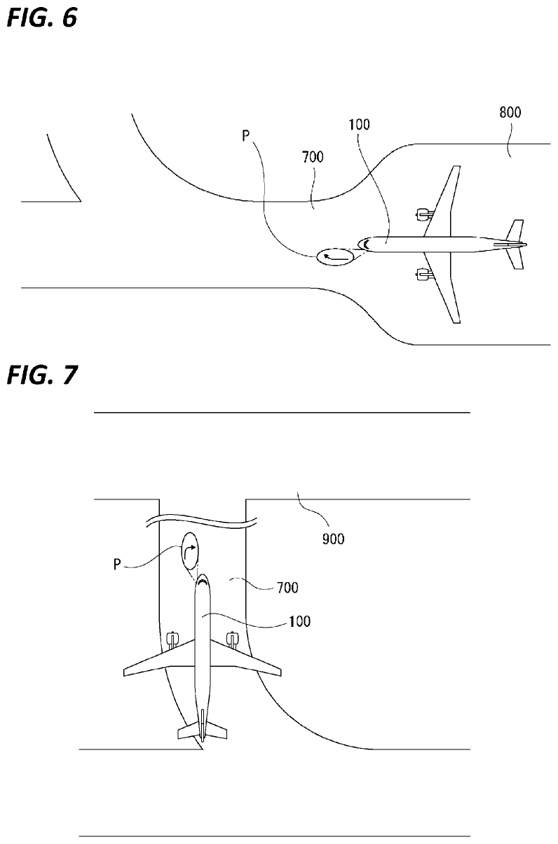

Next, an example in which the image P is projected in a state before take-off of the aircraft 100 will be described as a specific example implemented by the above control (see FIGS. 6 to 8).

When various works are performed on the aircraft 100 before take-off in a state where the aircraft 100 is waiting in a waiting area 800 such as a boarding area for passengers, when it is determined that the projection start trigger occurs, the image P that indicates the running direction of the aircraft 100 is projected on the road surface 700 by the aircraft projection device 1 (see FIG. 6). At this time, various works such as loading of luggage, inspection work, refueling work, or cleaning work are performed by the ground worker.

When all passengers and crew members are on board in the state where all the works are completed and the aircraft 100 is ready to take off, the aircraft 100 starts to travel toward a runway 900 before take-off. At this time, during the traveling toward the runway 900, the image P is displayed on the road surface 700 while the image P that indicates the correct running direction is switched (see FIG. 7). Therefore, it is possible for the pilot or the co-pilot to visually recognize the image P so as to confirm whether or not the aircraft 100 travels in the correct running direction.

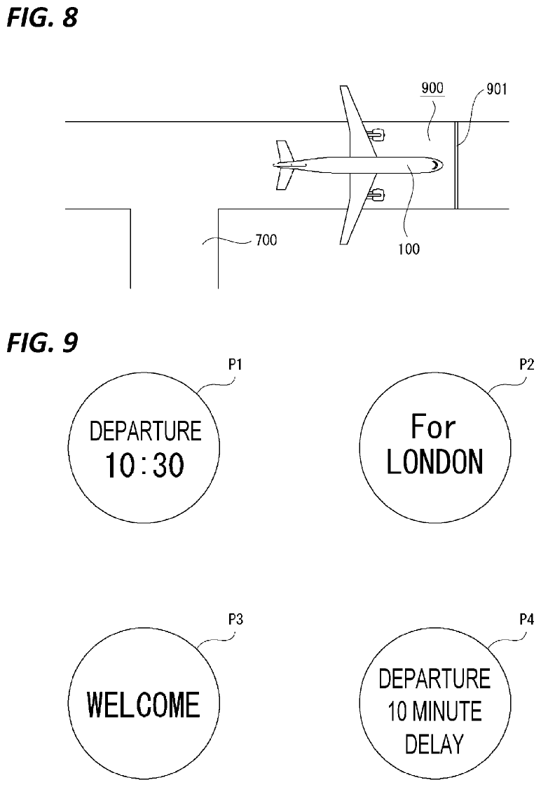

When the aircraft 100 that has traveled toward the runway 900 reaches a start line 901 of the runway 900, the aircraft 100 is stopped for the moment, and waits until a traveling allowance command for the runway 900 is issued from the control tower (see FIG. 8). At this time, it is determined that the projection end trigger occurs, and the projection of the image P is ended. Therefore, the display of the image P onto the road surface 700 is ended.

As described above, during the traveling of the aircraft 100 to the start line 901 of the runway 900, the image P that indicates the correct running direction is displayed on the road surface 700 while the image P is switched, which becomes reliable guide for the pilot or the co-pilot.

Although the example related to the projection of the image P has been described above, various display shapes or projection timings are considered as an example of the display of the image P as follows.

For example, when the aircraft 100 has landed and then travels from the runway 900 to the waiting area 800 such as a passenger drop-off area, the image P that indicates the correct running direction may be displayed. The display of such image P becomes a reliable guide to the waiting area 800 for the pilot or the co-pilot. Further, by displaying the running direction as the image P, it is possible to facilitate communication with a ground guide (marshaller) who guides the running of the aircraft 100.

Further, as the image P, a warning mark for ground worker may be displayed (see FIG. 9). As such display, for example, an image P1 that indicates a scheduled take-off time or an image P2 that indicates a destination is assumed. By displaying the image P1 that indicates the scheduled take-off time or the time until departure, it is possible for the ground worker to confirm the time at which the work should be finished, and by displaying the image P2 of the destination, it is possible to prevent an error in the loading destination of the luggage by the ground worker.

Further, the image P may be, for example, a welcome image P3 that indicates that passengers are currently on board, an image P4 that indicates a delay in departure time with respect to the scheduled time, an image that indicates a state currently preparing for boarding, an image that indicates an emergency state, an image that indicates a logo of an airline. Further, the respective images P may be displayed in different colors or blinking depending on the purpose of use.

As in each of the above examples, the image P may have various display shapes. However, in the embodiment, at least the projector 4 of the aircraft projection device 1 is attached to the inner surface 104a of the storage cover 104 that opens and closes the front leg 200 that is taken in and out of the fuselage 102.

Therefore, since it is possible to use the projector 4 in the state where the storage cover 104 is opened, the projector 4 may be protected during the flight, and it is possible to reduce the manufacturing cost without the need for a dedicated arrangement portion configured to dispose the projector 4.

Further, since the projector 4 displays the running direction he aircraft 100 as the image P, and the running direction of the aircraft 100 is displayed on the road surface 700 during take-off and landing, it is possible for the pilot to recognize the running direction of the aircraft 100 with the naked eye, and to smoothly travel the aircraft 100 on the correct travel route during take-off and landing.

Further, since the projector 4 displays the running direction of the aircraft 100 as the image P, and the running direction the aircraft 100 is displayed on the road surface 700 during take-off and landing, it is possible for the ground worker to recognize the running direction of the aircraft 100 with the naked eye, and to wait at a position retracted from the traveling route of the aircraft 100 during take-off and landing, and thus, it is possible to improve safety.

Meanwhile, since the projector 4 displays the warning mark as the image P, the warning mark is displayed on the road surface 700 at take-off and landing, it is possible for the ground worker to recognize the warning state with the naked eye, so that the safety during take-off and landing may be improved.

Meanwhile, the image P functions as a display that is clear and easy to recognize by being displayed on the road surface 700 at night, but the display of the image P is not limited to the night and may be displayed in the daytime. Further, the image P is not limited to characters, and may be a figure or a mark. As described above, the aircraft projection device 1 includes the projector 4 that is attached to the airframe 101 of the aircraft 100 and is used in the landing state, and projects and displays the image P on the road surface 700 outside the aircraft 100, and the controller 2 that controls the projector 4 to display the image P.

Therefore, it is possible for the pilot or the around worker to visually recognize the image P displayed on the road surface 700 outside the aircraft 100 to recognize provided matters for the pilot or the ground worker, so that the convenience for the pilot or the ground worker may be improved.

Meanwhile, in the aircraft projection device 1, it is possible to emit the projecting light directly downward from the projector 4, and to display the image P directly below the projector 4.

As described above, by emitting the projecting light directly downward from the projector 4 and displaying the image P directly below the projector 4, the distance from the projector 4 to each display portion in the image P does not differ significantly, and thus, the shape of the image P or characters displayed on the road surface 700 are unlikely to he distorted, and the clear image P may be displayed on the road surface 700.

Meanwhile, the aircraft projection device I may he provided with a sensor unit such as a speed sensor, and be configured to occur the projection start trigger or the projection end trigger based on the detection information by the sensor unit. In this case, for example, it is possible to configure such that the traveling speed of the aircraft is detected by the speed sensor, and the projection start trigger occurs when it is detected that the traveling speed is less than a certain value, and the projection end trigger occurs when it is detected that the traveling speed is equal to or higher than a certain value.

### DESCRIPTION OF SYMBOLS

1: aircraft projection device

2: controller

4: projector

100: aircraft

101: airframe

104: storage cover

700: road surface

1. A vehicle lamp comprising:

1. An aircraft projection device comprising:
a projector attached to an airframe of an aircraft and configured to project and display an image on a road surface outside the aircraft in a landing state; and
a controller configured to control the projector to display the image.

2. The aircraft projection device according to claim 1, wherein projecting light is emitted direct town and from the projector.

3. The aircraft projection device according to claim 1, wherein the projector is attached to an inner surface of a storage cover that opens and closes a front leg that is taken in and out of a fuselage of the aircraft.

4. The aircraft projection device according to claim 1, wherein the projector displays a running direction of the aircraft as an image.

5. The aircraft projection device according to claim 1, wherein the projector displays a warning mark as an image.
